(19) United States
(12) Patent Application Publication
(10) Pub. No.: US 2016/0302094 A1
(43) Pub. Date: Oct. 13, 2016

(54) METHOD OF MEASURING RADIO RESOURCE AND APPARATUS THEREFOR

(71) Applicant: LG ELECTRONICS INC., Seoul (KR)

(72) Inventors: Kunil YUM, Seoul (KR); Yunjung YI, Seoul (KR)

(73) Assignee: LG ELECTRONICS INC., Seoul (KR)

(21) Appl. No.: 15/094,719

(22) Filed: Apr. 8, 2016

Related U.S. Application Data
(60) Provisional application No. 62/144,947, filed on Apr. 9, 2015.

(51) Int. Cl. H04W 24/08; H04W 24/10

(52) U.S. Cl. CPC H04W 24/08; H04W 24/10

(57) ABSTRACT

A method of measuring and reporting radio resources by a mobile terminal operating while retuning to a plurality of subbands in a wireless communication system, comprising receiving measurement configuration including one or more subbands for measuring a reference signal received power from a specific cell and measuring a reference signal received power in an operating subband of the mobile terminal when the operating subband of the mobile terminal matches the measurement configuration.

### CROSS-REFERENCE TO RELATED APPLICATION

Pursuant to 35 U.S.C. §119(e), this application claims the benefit of U.S. Provisional Application No. 62/144,947, filed on Apr. 9, 2015, the contents of which are hereby incorporated by reference herein in its entirety.

### BACKGROUND OF THE INVENTION

1. Field of the Invention

The present invention relates to a wireless communication system, and more particularly, to a method and apparatus for measuring radio resource.

2. Discussion of the Related Art

Recently, various devices requiring machine-to-machine (M2M) communication and high data transfer rate, such as smartphones or tablet personal computers (PCs), have appeared and come into widespread use. This has rapidly increased the quantity of data which needs to be processed in a cellular network. In order to satisfy such rapidly increasing data throughput, recently, carrier aggregation (CA) technology which efficiently uses more frequency bands, cognitive ratio technology, multiple antenna (MIMO) technology for increasing data capacity in a restricted frequency, multiple-base-station cooperative technology, etc. have been highlighted. In addition, communication environments have evolved such that the density of accessible nodes is increased in the vicinity of a user equipment (UE). Here, the node includes one or more antennas and refers to a fixed point capable of transmitting/receiving radio frequency (RF) signals to/from the user equipment (UE). A communication system including high-density nodes may provide a communication service of higher performance to the UE by cooperation between nodes.

A multi-node coordinated communication scheme in which a plurality of nodes communicates with a user equipment (UE) using the same time-frequency resources has much higher data throughput than legacy communication scheme in which each node operates as an independent base station (BS) to communicate with the UE without cooperation.

A multi-node system performs coordinated communication using a plurality of nodes, each of which operates as a base station or an access point, an antenna, an antenna group, a remote radio head (RRH), and a remote radio unit (RRU). Unlike the conventional centralized antenna system in which antennas are concentrated at a base station (BS), nodes are spaced apart from each other by a predetermined distance or more in the multi-node system. The nodes can be managed by one or more base stations or base station controllers which control operations of the nodes or schedule data transmitted/received through the nodes. Each node is connected to a base station or a base station controller which manages the node through a cable or a dedicated line.

The multi-node system can be considered as a kind of Multiple Input Multiple Output (MIMO) system since dispersed nodes can communicate with a single UE or multiple UEs by simultaneously transmitting/receiving different data streams. However, since the multi-node system transmits signals using the dispersed nodes, a transmission area covered by each antenna is reduced compared to antennas included in the conventional centralized antenna system. Accordingly, transmit power required for each antenna to transmit a signal in the multi-node system can be reduced compared to the conventional centralized antenna system using MIMO. In addition, a transmission distance between an antenna and a UE is reduced to decrease in pathloss and enable rapid data transmission in the multi-node system. This can improve transmission capacity and power efficiency of a cellular system and meet communication performance having relatively uniform quality regardless of UE locations in a cell. Further, the multi-node system reduces signal loss generated during transmission since base station(s) or base station controller(s) connected to a plurality of nodes transmit/receive data in cooperation with each other. When nodes spaced apart by over a predetermined distance perform coordinated communication with a UE, correlation and interference between antennas are reduced. Therefore, a high signal to interference-plus-noise ratio (SINR) can be obtained according to the multi-node coordinated communication scheme.

Owing to the above-mentioned advantages of the multi-node system, the multi-node system is used with or replaces the conventional centralized antenna system to become a new foundation of cellular communication in order to reduce base station cost and backhaul network maintenance cost while extending service coverage and improving channel capacity and SINR in next-generation mobile communication systems.

### SUMMARY OF THE INVENTION

The present invention is directed to a method and apparatus for measuring radio resource.

According to an embodiment of the present invention, there is provided a method of measuring and reporting radio resources by a mobile terminal operating while retuning to a plurality of subbands in a wireless communication system, comprising: receiving measurement configuration including one or more subbands for measuring a reference signal received power from a specific cell and measuring a reference signal received power in an operating subband of the mobile terminal when the operating subband of the mobile terminal matches the measurement configuration.

Alternatively or additionally, the measurement configuration may be received through control information indicating one of a plurality of subband sets configured for the mobile terminal.

Alternatively or additionally, the measurement configuration may include information about a measurement time duration for measuring the reference signal received power, the information about the measurement time duration may include duration, period or offset of the measurement time duration for measuring the reference signal receive power.

Alternatively or additionally, the measurement time duration may correspond to a measurement gap for inter-frequency measurement, configured for the mobile terminal.

Alternatively or additionally, the method may further comprises measuring a reference signal received power for a neighboring cell in the measurement time duration corresponding to the measurement gap.

Alternatively or additionally, the operating subband may include a specific number of resource blocks (RBs) in the center of a system bandwidth when the mobile terminal needs to receive a PSS/SSS (primary synchronization signal/secondary synchronization signal) in a discontinuous reception (DRX) mode.

Alternatively or additionally, the operating subband may include a subband monitored by the mobile terminal when the UE is not in the DRX mode.

Alternatively or additionally, the operating subband may include a subband monitored by the UE when the UE is in an RRC_IDLE state.

According to an embodiment of the present invention, there is provided a mobile terminal configured to measure and report radio resources in a wireless communication system and to operate while retuning to a plurality of subbands, comprising: a radio frequency (RF) unit; and a processor configured to control the RF unit, wherein the processor may be configured to receive measurement configuration including one or more subbands for measuring a reference signal received power from a specific cell and to measure a reference signal received power in an operating subband of the mobile terminal when the operating subband of the mobile terminal corresponds to the measurement configuration.

Alternatively or additionally, the measurement configuration may be received through control information indicating one of a plurality of subband sets configured for the mobile terminal.

Alternatively or additionally, the measurement configuration may include information about a measurement time duration for measuring the reference signal received power, the information about the measurement time duration may include duration, period or offset of the measurement time duration for measuring the reference signal receive power.

Alternatively or additionally, the measurement time duration may correspond to a measurement gap for inter-frequency measurement, configured for the mobile terminal.

Alternatively or additionally, the processor may be configured to measure a reference signal received power for a neighboring cell in the measurement time duration corresponding to the measurement gap.

Alternatively or additionally, the operating subband may include a specific number of resource blocks (RBs) in the center of a system bandwidth when the mobile terminal needs to receive a PSS/SSS (primary synchronization signal/secondary synchronization signal) in a discontinuous reception (DRX) mode.

Alternatively or additionally, the operating subband may include a subband monitored by the mobile terminal when the mobile terminal is not in the DRX mode.

Alternatively or additionally, the operating subband may include a subband monitored by the mobile terminal when the mobile terminal is in an RRC_IDLE state.

The aforementioned technical solutions are merely parts of embodiments of the present invention and various embodiments in which the technical features of the present invention are reflected can be derived and understood by a person skilled in the art on the basis of the following detailed description of the present invention.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates exemplary radio frame structures in a wireless communication system;

FIG. 2 illustrates an exemplary structure of a downlink (DL)/uplink (UL) slot in a wireless communication system;

FIG. 3 illustrates an exemplary structure of a DL subframe in a 3^{rd} generation partnership project (3GPP) long term evolution (LTE)/LTE-advanced (LTE-A) system;

FIG. 4 illustrates an exemplary structure of a UL subframe in the 3GPP LTE/LTE-A system;

FIG. 5 illustrates an operation according to an embodiment of the present invention; and

FIG. 6 is a block diagram of devices for implementing an embodiment(s) of the present invention.

### DETAILED DESCRIPTION OF THE INVENTION

Reference will now be made in detail to the preferred embodiments of the present invention, examples of which are illustrated in the accompanying drawings. The accompanying drawings illustrate exemplary embodiments of the present invention and provide a more detailed description of the present invention. However, the scope of the present invention should not be limited thereto.

In some cases, to prevent the concept of the present invention from being ambiguous, structures and apparatuses of the known art will be omitted, or will be shown in the form of a block diagram based on main functions of each structure and apparatus. Also, wherever possible, the same reference numbers will be used throughout the drawings and the specification to refer to the same or like parts.

In the present invention, a user equipment (UE) is fixed or mobile. The UE is a device that transmits and receives user data and/or control information by communicating with a base station (BS). The term ‘UE’ may be replaced with ‘terminal equipment’, ‘Mobile Station (MS)’, ‘Mobile Terminal (MT)’, ‘User Terminal (UT)’, ‘Subscriber Station (SS)’, ‘wireless device’, ‘Personal Digital Assistant (PDA)’, ‘wireless modem’, ‘handheld device’, etc. A BS is typically a fixed station that communicates with a UE and/or another BS. The BS exchanges data and control information with a UE and another BS. The term ‘BS’ may be replaced with ‘Advanced Base Station (ABS)’, ‘Node B’, ‘evolved-Node B (eNB)’, ‘Base Transceiver System (BTS)’, ‘Access Point (AP)’, ‘Processing Server (PS)’, etc. In the following description, BS is commonly called eNB.

In the present invention, a node refers to a fixed point capable of transmitting/receiving a radio signal to/from a UE by communication with the UE. Various eNBs can be used as nodes. For example, a node can be a BS, NB, eNB, pico-cell eNB (PeNB), home eNB (HeNB), relay, repeater, etc. Furthermore, a node may not be an eNB. For example, a node can be a radio remote head (RRH) or a radio remote unit (RRU). The RRH and RRU have power levels lower than that of the eNB. Since the RRH or RRU (referred to as RRH/RRU hereinafter) is connected to an eNB through a dedicated line such as an optical cable in general, cooperative communication according to RRH/RRU and eNB can be smoothly performed compared to cooperative communication according to eNBs connected through a wireless link. At least one antenna is installed per node. An antenna may refer to an antenna port, a virtual antenna or an antenna group. A node may also be called a point. Unlink a conventional centralized antenna system (CAS) (i.e. single node system) in which antennas are concentrated in an eNB and controlled an eNB controller, plural nodes are spaced apart at a predetermined distance or longer in a multi-node system. The plural nodes can be managed by one or more eNBs or eNB controllers that control operations of the nodes or schedule data to be transmitted/received through the nodes. Each node may be connected to an eNB or eNB controller managing the corresponding node via a cable or a dedicated line. In the multi-node system, the same cell identity (ID) or different cell IDs may be used for signal transmission/reception through plural nodes. When plural nodes have the same cell ID, each of the plural nodes operates as an antenna group of a cell. If nodes have different cell IDs in the multi-node system, the multi-node system can be regarded as a multi-cell (e.g., macro-cell/femto-cell/pico-cell) system. When multiple cells respectively configured by plural nodes are overlaid according to coverage, a network configured by multiple cells is called a multi-tier network. The cell ID of the RRH/RRU may be identical to or different from the cell ID of an eNB. When the RRH/RRU and eNB use different cell IDs, both the RRH/RRU and eNB operate as independent eNBs.

In a multi-node system according to the present invention, which will be described below, one or more eNBs or eNB controllers connected to plural nodes can control the plural nodes such that signals are simultaneously transmitted to or received from a UE through some or all nodes. While there is a difference between multi-node systems according to the nature of each node and implementation form of each node, multi-node systems are discriminated from single node systems (e.g. CAS, conventional MIMO systems, conventional relay systems, conventional repeater systems, etc.) since a plurality of nodes provides communication services to a UE in a predetermined time-frequency resource. Accordingly, embodiments of the present invention with respect to a method of performing coordinated data transmission using some or all nodes can be applied to various types of multi-node systems. For example, a node refers to an antenna group spaced apart from another node by a predetermined distance or more, in general. However, embodiments of the present invention, which will be described below, can even be applied to a case in which a node refers to an arbitrary antenna group irrespective of node interval. In the case of an eNB including an X-pole (cross polarized) antenna, for example, the embodiments of the preset invention are applicable on the assumption that the eNB controls a node composed of an H-pole antenna and a V-pole antenna.

A communication scheme through which signals are transmitted/received via plural transmit (Tx)/receive (Rx) nodes, signals are transmitted/received via at least one node selected from plural Tx/Rx nodes, or a node transmitting a downlink signal is discriminated from a node transmitting an uplink signal is called multi-eNB MIMO or CoMP (Coordinated Multi-Point Tx/Rx). Coordinated transmission schemes from among CoMP communication schemes can be categorized into JP (Joint Processing) and scheduling coordination. The former may be divided into JT (Joint Transmission)/JR (Joint Reception) and DPS (Dynamic Point Selection) and the latter may be divided into CS (Coordinated Scheduling) and CB (Coordinated Beamforming). DPS may be called DCS (Dynamic Cell Selection). When JP is performed, more various communication environments can be generated, compared to other CoMP schemes. JT refers to a communication scheme by which plural nodes transmit the same stream to a UE and JR refers to a communication scheme by which plural nodes receive the same stream from the UE. The UE/eNB combine signals received from the plural nodes to restore the stream. In the case of JT/JR, signal transmission reliability can be improved according to transmit diversity since the same stream is transmitted from/to plural nodes. DPS refers to a communication scheme by which a signal is transmitted/received through a node selected from plural nodes according to a specific rule. In the case of DPS, signal transmission reliability can be improved because a node having a good channel state between the node and a UE is selected as a communication node.

In the present invention, a cell refers to a specific geographical area in which one or more nodes provide communication services. Accordingly, communication with a specific cell may mean communication with an eNB or a node providing communication services to the specific cell. A downlink/uplink signal of a specific cell refers to a downlink/uplink signal from/to an eNB or a node providing communication services to the specific cell. A cell providing uplink/downlink communication services to a UE is called a serving cell. Furthermore, channel status/quality of a specific cell refers to channel status/quality of a channel or a communication link generated between an eNB or a node providing communication services to the specific cell and a UE. In 3GPP LTE-A systems, a UE can measure downlink channel state from a specific node using one or more CSI-RSs (Channel State Information Reference Signals) transmitted through antenna port(s) of the specific node on a CSI-RS resource allocated to the specific node. In general, neighboring nodes transmit CSI-RS resources on orthogonal CSI-RS resources. When CSI-RS resources are orthogonal, this means that the CSI-RS resources have different subframe configurations and/or CSI-RS sequences which specify subframes to which CSI-RSs are allocated according to CSI-RS resource configurations, subframe offsets and transmission periods, etc. which specify symbols and subcarriers carrying the CSI RSs.

In the present invention, PDCCH (Physical Downlink Control Channel)/PCFICH (Physical Control Format Indicator Channel)/PHICH (Physical Hybrid automatic repeat request Indicator Channel)/PDSCH (Physical Downlink Shared Channel) refer to a set of time-frequency resources or resource elements respectively carrying DCI (Downlink Control Information)/CFI (Control Format Indicator)/downlink ACK/NACK (Acknowledgement/Negative ACK)/downlink data. In addition, PUCCH (Physical Uplink Control Channel)/PUSCH (Physical Uplink Shared Channel)/PRACH (Physical Random Access Channel) refer to sets of time-frequency resources or resource elements respectively carrying UCI (Uplink Control Information)/uplink data/random access signals. In the present invention, a time-frequency resource or a resource element (RE), which is allocated to or belongs to PDCCH/PCFICH/PHICH/PDSCH/PUCCH/PUSCH/PRACH, is referred to as a PDCCH/PCFICH/PHICH/PDSCH/PUCCH/PUSCH/PRACH RE or PDCCH/PCFICH/PHICH/PDSCH/PUCCH/PUSCH/PRACH resource. In the following description, transmission of PUCCH/PUSCH/PRACH by a UE is equivalent to transmission of uplink control information/uplink data/random access signal through or on PUCCH/PUSCH/PRACH. Furthermore, transmission of PDCCH/PCFICH/PHICH/PDSCH by an eNB is equivalent to transmission of downlink data/control information through or on PDCCH/PCFICH/PHICH/PDSCH.

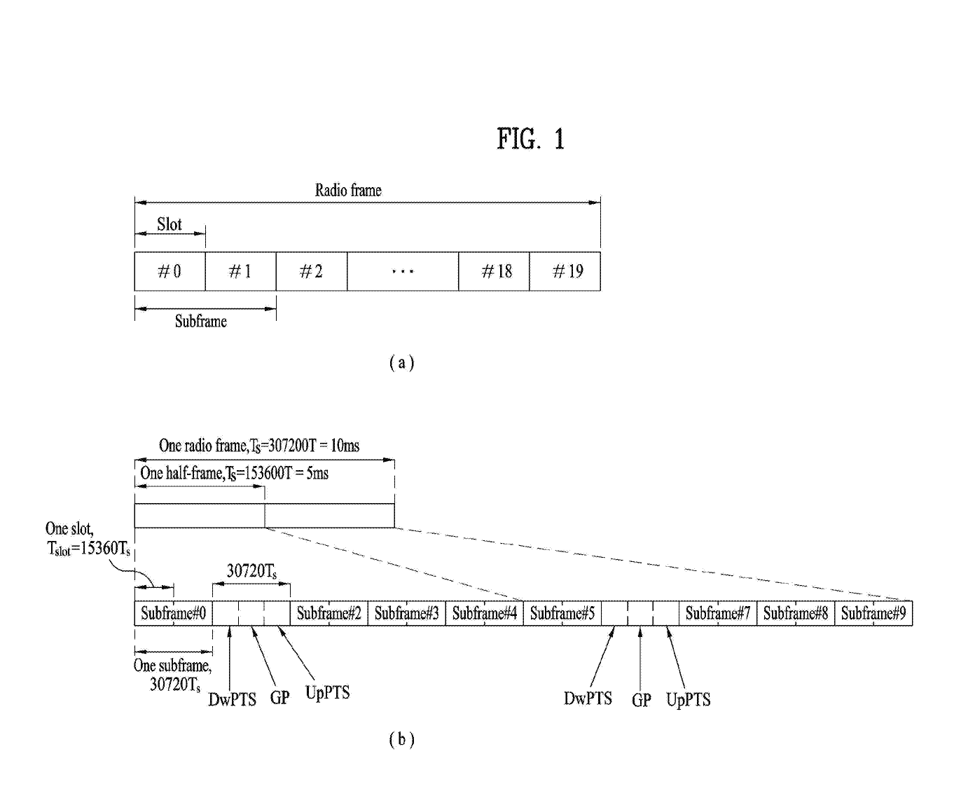

FIG. 1 illustrates an exemplary radio frame structure used in a wireless communication system. FIG. 1(a) illustrates a frame structure for frequency division duplex (FDD) used in 3GPP LTE/LTE-A and FIG. 1(b) illustrates a frame structure for time division duplex (TDD) used in 3GPP LTE/LTE-A.

Referring to FIG. 1, a radio frame used in 3GPP LTE/LTE-A has a length of 10 ms (307200 Ts) and includes 10 subframes in equal size. The 10 subframes in the radio frame may be numbered. Here, Ts denotes sampling time and is represented as Ts=1/(2048*15 kHz). Each subframe has a length of 1 ms and includes two slots. 20 slots in the radio frame can be sequentially numbered from 0 to 19. Each slot has a length of 0.5 ms. A time for transmitting a subframe is defined as a transmission time interval (TTI). Time resources can be discriminated by a radio frame number (or radio frame index), subframe number (or subframe index) and a slot number (or slot index).

The radio frame can be configured differently according to duplex mode. Downlink transmission is discriminated from uplink transmission by frequency in FDD mode, and thus the radio frame includes only one of a downlink subframe and an uplink subframe in a specific frequency band. In TDD mode, downlink transmission is discriminated from uplink transmission by time, and thus the radio frame includes both a downlink subframe and an uplink subframe in a specific frequency band.

Table 1 shows DL-UL configurations of subframes in a radio frame in the TDD mode.

TABLE 1

| | Downlink- | | | | | | | | | | |
|---|---|---|---|---|---|---|---|---|---|---|---|
| DL-UL | to-Uplink | | | | | | | | | | |
| configu- | Switch-point | Subframe number | | | | | | | | | |
| ration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 1, D denotes a downlink subframe, U denotes an uplink subframe and S denotes a special subframe. The special subframe includes three fields of DwPTS (Downlink Pilot TimeSlot), GP (Guard Period), and UpPTS (Uplink Pilot TimeSlot). DwPTS is a period reserved for downlink transmission and UpPTS is a period reserved for uplink transmission. Table 2 shows special subframe configuration.

TABLE 2

| | Normal cyclic prefix in downlink | | | Extended cyclic prefix in downlink | | |
|---|---|---|---|---|---|---|
| Special | | UpPTS | | | UpPTS | |
| subframe | | Normal cyclic | Extended cyclic | | Normal cyclic | Extended cyclic |
| configuration | DwPTS | prefix in uplink | prefix in uplink | DwPTS | prefix in uplink | prefix in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | 12800 · Tₛ | | |
| 8 | 24144 · Tₛ | | | — | — | — |
| 9 | 13168 · Tₛ | | | — | — | — |

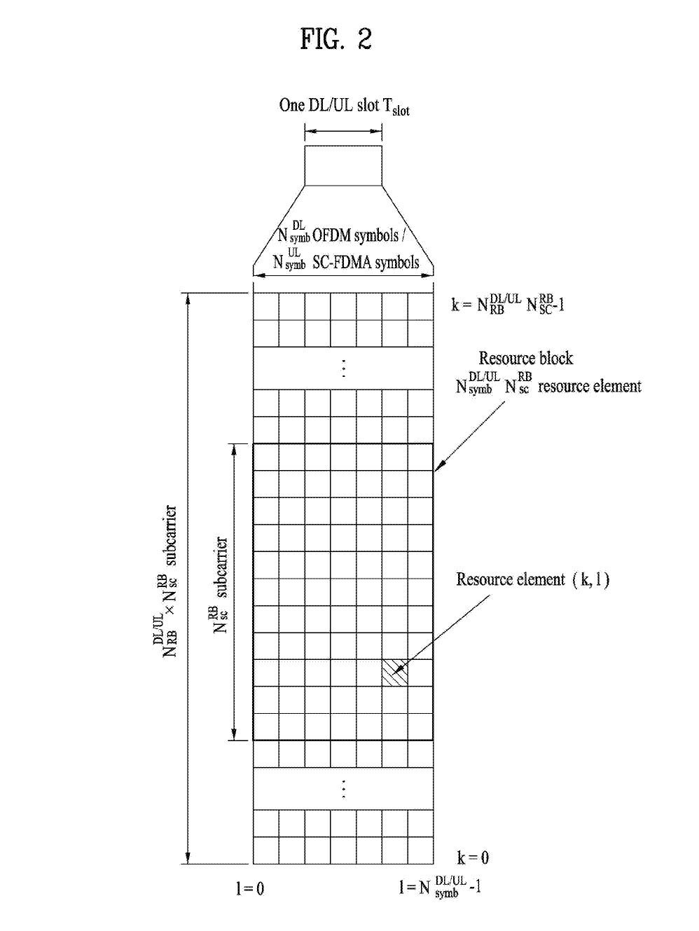

FIG. 2 illustrates an exemplary downlink/uplink slot structure in a wireless communication system. Particularly, FIG. 2 illustrates a resource grid structure in 3GPP LTE/LTE-A. A resource grid is present per antenna port.

Referring to FIG. 2, a slot includes a plurality of OFDM (Orthogonal Frequency Division Multiplexing) symbols in the time domain and a plurality of resource blocks (RBs) in the frequency domain. An OFDM symbol may refer to a symbol period. A signal transmitted in each slot may be represented by a resource grid composed of N_{RB}^{DL/UL}*N_{sc}^{RB} subcarriers and N_{symb}^{DL/UL} OFDM symbols. Here, N_{RB}^{DL} denotes the number of RBs in a downlink slot and N_{RB}^{UL} denotes the number of RBs in an uplink slot. N_{RB}^{DL} and N_{RB}^{UL} respectively depend on a DL transmission bandwidth and a UL transmission bandwidth. N_{symb}^{DL} denotes the number of OFDM symbols in the downlink slot and N_{symb}^{UL} denotes the number of OFDM symbols in the uplink slot. In addition, N_{sc}^{RB} denotes the number of subcarriers constructing one RB.

An OFDM symbol may be called an SC-FDM (Single Carrier Frequency Division Multiplexing) symbol according to multiple access scheme. The number of OFDM symbols included in a slot may depend on a channel bandwidth and the length of a cyclic prefix (CP). For example, a slot includes 7 OFDM symbols in the case of normal CP and 6 OFDM symbols in the case of extended CP. While FIG. 2 illustrates a subframe in which a slot includes 7 OFDM symbols for convenience, embodiments of the present invention can be equally applied to subframes having different numbers of OFDM symbols. Referring to FIG. 2, each OFDM symbol includes N_{RB}^{DL/UL}*N_{sc}^{RB} subcarriers in the frequency domain. Subcarrier types can be classified into a data subcarrier for data transmission, a reference signal subcarrier for reference signal transmission, and null subcarriers for a guard band and a direct current (DC) component. The null subcarrier for a DC component is a subcarrier remaining unused and is mapped to a carrier frequency (f0) during OFDM signal generation or frequency up-conversion. The carrier frequency is also called a center frequency.

An RB is defined by N_{symb}^{DL/UL} (e.g., 7) consecutive OFDM symbols in the time domain and N_{sc}^{RB} (e.g., 12) consecutive subcarriers in the frequency domain. For reference, a resource composed by an OFDM symbol and a subcarrier is called a resource element (RE) or a tone. Accordingly, an RB is composed of N_{symb}^{DL/UL}*N_{sc}^{RB} REs. Each RE in a resource grid can be uniquely defined by an index pair (k, l) in a slot. Here, k is an index in the range of 0 to N_{symb}^{DL/UL}*N_{sc}^{RB}−1 in the frequency domain and l is an index in the range of 0 to N_{symb}^{DL/UL}−1.

Two RBs that occupy N_{sc}^{RB} consecutive subcarriers in a subframe and respectively disposed in two slots of the subframe are called a physical resource block (PRB) pair. Two RBs constituting a PRB pair have the same PRB number (or PRB index). A virtual resource block (VRB) is a logical resource allocation unit for resource allocation. The VRB has the same size as that of the PRB. The VRB may be divided into a localized VRB and a distributed VRB depending on a mapping scheme of VRB into PRB. The localized VRBs are mapped into the PRBs, whereby VRB number (VRB index) corresponds to PRB number. That is, nPRB=nVRB is obtained. Numbers are given to the localized VRBs from 0 to N_{VRB}^{DL}−1, and N_{VRB}^{DL}=N_{RB}^{DL} is obtained. Accordingly, according to the localized mapping scheme, the VRBs having the same VRB number are mapped into the PRBs having the same PRB number at the first slot and the second slot. On the other hand, the distributed VRBs are mapped into the PRBs through interleaving. Accordingly, the VRBs having the same VRB number may be mapped into the PRBs having different PRB numbers at the first slot and the second slot. Two PRBs, which are respectively located at two slots of the subframe and have the same VRB number, will be referred to as a pair of VRBs.

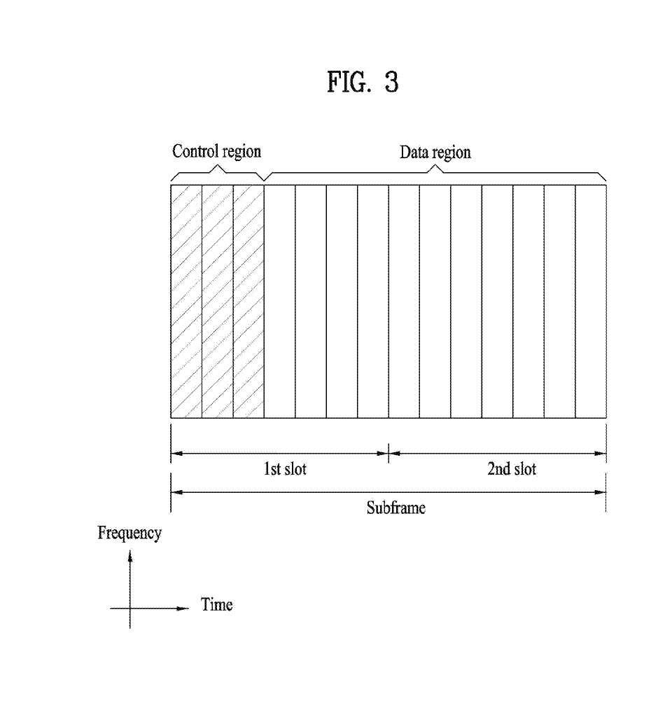

FIG. 3 illustrates a downlink (DL) subframe structure used in 3GPP LTE/LTE-A.

Referring to FIG. 3, a DL subframe is divided into a control region and a data region. A maximum of three (four) OFDM symbols located in a front portion of a first slot within a subframe correspond to the control region to which a control channel is allocated. A resource region available for PDCCH transmission in the DL subframe is referred to as a PDCCH region hereinafter. The remaining OFDM symbols correspond to the data region to which a physical downlink shared chancel (PDSCH) is allocated. A resource region available for PDSCH transmission in the DL subframe is referred to as a PDSCH region hereinafter. Examples of downlink control channels used in 3GPP LTE include a physical control format indicator channel (PCFICH), a physical downlink control channel (PDCCH), a physical hybrid ARQ indicator channel (PHICH), etc. The PCFICH is transmitted at a first OFDM symbol of a subframe and carries information regarding the number of OFDM symbols used for transmission of control channels within the subframe. The PHICH is a response of uplink transmission and carries an HARQ acknowledgment (ACK)/negative acknowledgment (NACK) signal.

Control information carried on the PDCCH is called downlink control information (DCI). The DCI contains resource allocation information and control information for a UE or a UE group. For example, the DCI includes a transport format and resource allocation information of a downlink shared channel (DL-SCH), a transport format and resource allocation information of an uplink shared channel (UL-SCH), paging information of a paging channel (PCH), system information on the DL-SCH, information about resource allocation of an upper layer control message such as a random access response transmitted on the PDSCH, a transmit control command set with respect to individual UEs in a UE group, a transmit power control command, information on activation of a voice over IP (VoIP), downlink assignment index (DAI), etc. The transport format and resource allocation information of the DL-SCH are also called DL scheduling information or a DL grant and the transport format and resource allocation information of the UL-SCH are also called UL scheduling information or a UL grant. The size and purpose of DCI carried on a PDCCH depend on DCI format and the size thereof may be varied according to coding rate. Various formats, for example, formats 0 and 4 for uplink and formats 1, 1A, 1B, 1C, 1D, 2, 2A, 2B, 2C, 3 and 3A for downlink, have been defined in 3GPP LTE. Control information such as a hopping flag, information on RB allocation, modulation coding scheme (MCS), redundancy version (RV), new data indicator (NDI), information on transmit power control (TPC), cyclic shift demodulation reference signal (DMRS), UL index, channel quality information (CQI) request, DL assignment index, HARQ process number, transmitted precoding matrix indicator (TPMI), precoding matrix indicator (PMI), etc. is selected and combined based on DCI format and transmitted to a UE as DCI.

In general, a DCI format for a UE depends on transmission mode (TM) set for the UE. In other words, only a DCI format corresponding to a specific TM can be used for a UE configured in the specific TM.

A PDCCH is transmitted on an aggregation of one or several consecutive control channel elements (CCEs). The CCE is a logical allocation unit used to provide the PDCCH with a coding rate based on a state of a radio channel. The CCE corresponds to a plurality of resource element groups (REGs). For example, a CCE corresponds to 9 REGs and an REG corresponds to 4 REs. 3GPP LTE defines a CCE set in which a PDCCH can be located for each UE. A CCE set from which a UE can detect a PDCCH thereof is called a PDCCH search space, simply, search space. An individual resource through which the PDCCH can be transmitted within the search space is called a PDCCH candidate. A set of PDCCH candidates to be monitored by the UE is defined as the search space. In 3GPP LTE/LTE-A, search spaces for DCI formats may have different sizes and include a dedicated search space and a common search space. The dedicated search space is a UE-specific search space and is configured for each UE. The common search space is configured for a plurality of UEs. Aggregation levels defining the search space is as follows.

TABLE 3

| Search Space | | | Number of PDCCH |
|---|---|---|---|
| Type | Aggregation Level L | Size [in CCEs] | candidates M^{(L)} |
| UE- | 1 | 6 | 6 |
| specific | 2 | 12 | 6 |
| | 4 | 8 | 2 |
| | 8 | 16 | 2 |
| Common | 4 | 16 | 4 |
| | 8 | 16 | 2 |

A PDCCH candidate corresponds to 1, 2, 4 or 8 CCEs according to CCE aggregation level. An eNB transmits a PDCCH (DCI) on an arbitrary PDCCH candidate with in a search space and a UE monitors the search space to detect the PDCCH (DCI). Here, monitoring refers to attempting to decode each PDCCH in the corresponding search space according to all monitored DCI formats. The UE can detect the PDCCH thereof by monitoring plural PDCCHs. Since the UE does not know the position in which the PDCCH thereof is transmitted, the UE attempts to decode all PDCCHs of the corresponding DCI format for each subframe until a PDCCH having the ID thereof is detected. This process is called blind detection (or blind decoding (BD)).

The eNB can transmit data for a UE or a UE group through the data region. Data transmitted through the data region may be called user data. For transmission of the user data, a physical downlink shared channel (PDSCH) may be allocated to the data region. A paging channel (PCH) and downlink-shared channel (DL-SCH) are transmitted through the PDSCH. The UE can read data transmitted through the PDSCH by decoding control information transmitted through a PDCCH. Information representing a UE or a UE group to which data on the PDSCH is transmitted, how the UE or UE group receives and decodes the PDSCH data, etc. is included in the PDCCH and transmitted. For example, if a specific PDCCH is CRC (cyclic redundancy check)-masked having radio network temporary identify (RNTI) of “A” and information about data transmitted using a radio resource (e.g., frequency position) of “B” and transmission format information (e.g., transport block size, modulation scheme, coding information, etc.) of “C” is transmitted through a specific DL subframe, the UE monitors PDCCHs using RNTI information and a UE having the RNTI of “A” detects a PDCCH and receives a PDSCH indicated by “B” and “C” using information about the PDCCH.

A reference signal (RS) to be compared with a data signal is necessary for the UE to demodulate a signal received from the eNB. A reference signal refers to a predetermined signal having a specific waveform, which is transmitted from the eNB to the UE or from the UE to the eNB and known to both the eNB and UE. The reference signal is also called a pilot. Reference signals are categorized into a cell-specific RS shared by all UEs in a cell and a modulation RS (DM RS) dedicated for a specific UE. A DM RS transmitted by the eNB for demodulation of downlink data for a specific UE is called a UE-specific RS. Both or one of DM RS and CRS may be transmitted on downlink. When only the DM RS is transmitted without CRS, an RS for channel measurement needs to be additionally provided because the DM RS transmitted using the same precoder as used for data can be used for demodulation only. For example, in 3GPP LTE(-A), CSI-RS corresponding to an additional RS for measurement is transmitted to the UE such that the UE can measure channel state information. CSI-RS is transmitted in each transmission period corresponding to a plurality of subframes based on the fact that channel state variation with time is not large, unlike CRS transmitted per subframe.

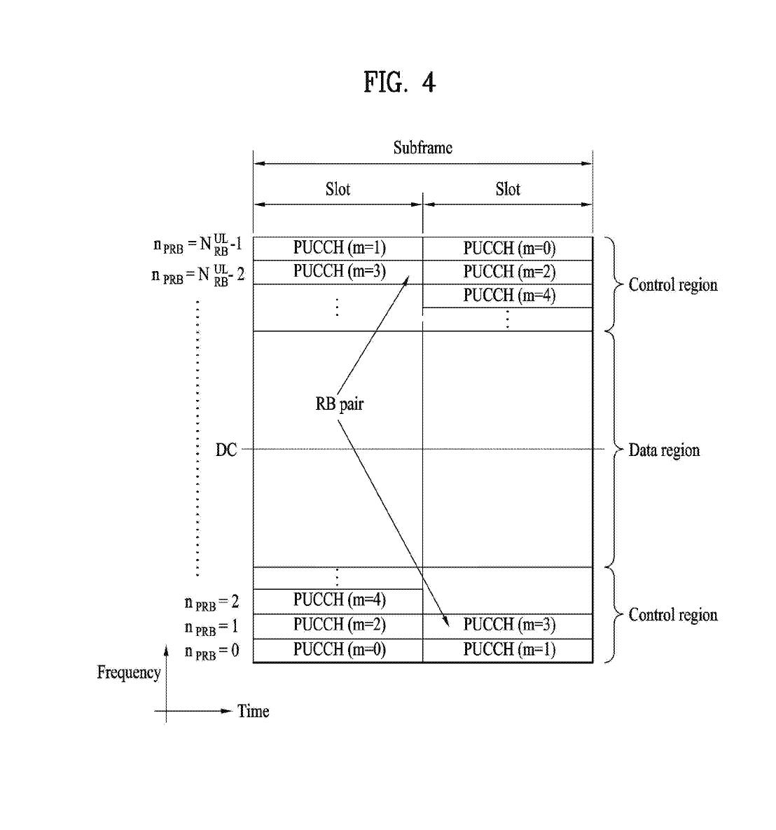

FIG. 4 illustrates an exemplary uplink subframe structure used in 3GPP LTE/LTE-A.

Referring to FIG. 4, a UL subframe can be divided into a control region and a data region in the frequency domain. One or more PUCCHs (physical uplink control channels) can be allocated to the control region to carry uplink control information (UCI). One or more PUSCHs (Physical uplink shared channels) may be allocated to the data region of the UL subframe to carry user data.

In the UL subframe, subcarriers spaced apart from a DC subcarrier are used as the control region. In other words, subcarriers corresponding to both ends of a UL transmission bandwidth are assigned to UCI transmission. The DC subcarrier is a component remaining unused for signal transmission and is mapped to the carrier frequency f0 during frequency up-conversion. A PUCCH for a UE is allocated to an RB pair belonging to resources operating at a carrier frequency and RBs belonging to the RB pair occupy different subcarriers in two slots. Assignment of the PUCCH in this manner is represented as frequency hopping of an RB pair allocated to the PUCCH at a slot boundary. When frequency hopping is not applied, the RB pair occupies the same subcarrier.

The PUCCH can be used to transmit the following control information.
Scheduling Request (SR): This is information used to request a UL-SCH resource and is transmitted using On-Off Keying (OOK) scheme.
HARQ ACK/NACK: This is a response signal to a downlink data packet on a PDSCH and indicates whether the downlink data packet has been successfully received. A 1-bit ACK/NACK signal is transmitted as a response to a single downlink codeword and a 2-bit ACK/NACK signal is transmitted as a response to two downlink codewords. HARQ-ACK responses include positive ACK (ACK), negative ACK (NACK), discontinuous transmission (DTX) and NACK/DTX. Here, the term HARQ-ACK is used interchangeably with the term HARQ ACK/NACK and ACK/NACK.
Channel State Indicator (CSI): This is feedback information about a downlink channel. Feedback information regarding MIMO includes a rank indicator (RI) and a precoding matrix indicator (PMI).

The quantity of control information (UCI) that a UE can transmit through a subframe depends on the number of SC-FDMA symbols available for control information transmission. The SC-FDMA symbols available for control information transmission correspond to SC-FDMA symbols other than SC-FDMA symbols of the subframe, which are used for reference signal transmission. In the case of a subframe in which a sounding reference signal (SRS) is configured, the last SC-FDMA symbol of the subframe is excluded from the SC-FDMA symbols available for control information transmission. A reference signal is used to detect coherence of the PUCCH. The PUCCH supports various formats according to information transmitted thereon.

Table 4 shows the mapping relationship between PUCCH formats and UCI in LTE/LTE-A.

TABLE 4

| | | Number of | | |
|---|---|---|---|---|
| | | bits per | | |
| PUCCH | Modulation | subframe, | | |
| format | scheme | M_{bit} | Usage | Etc. |
| 1 | N/A | N/A | SR (Scheduling | |
| | | | Request) | |
| 1a | BPSK | 1 | ACK/NACK or | One |
| | | | SR + ACK/NACK | codeword |
| 1b | QPSK | 2 | ACK/NACK or | Two |
| | | | SR + ACK/NACK | codeword |
| 2 | QPSK | 20 | CQI/PMI/RI | Joint coding |
| | | | | ACK/NACK |
| | | | | (extended |
| | | | | CP) |
| 2a | QPSK + BPSK | 21 | CQI/PMI/RI + | Normal CP |
| | | | ACK/NACK | only |
| 2b | QPSK + QPSK | 22 | CQI/PMI/RI + | Normal CP |
| | | | ACK/NACK | only |
| 3 | QPSK | 48 | ACK/NACK or | |
| | | | SR + ACK/NACK | |
| | | | or CQI/PMI/RI + | |
| | | | ACK/NACK | |

Referring to Table 4, PUCCH formats 1/1a/1b are used to transmit ACK/NACK information, PUCCH format 2/2a/2b are used to carry CSI such as CQI/PMFRI and PUCCH format 3 is used to transmit ACK/NACK information.

Reference Signal (RS)

When a packet is transmitted in a wireless communication system, signal distortion may occur during transmission since the packet is transmitted through a radio channel. To correctly receive a distorted signal at a receiver, the distorted signal needs to be corrected using channel information. To detect channel information, a signal known to both a transmitter and the receiver is transmitted and channel information is detected with a degree of distortion of the signal when the signal is received through a channel. This signal is called a pilot signal or a reference signal.

When data is transmitted/received using multiple antennas, the receiver can receive a correct signal only when the receiver is aware of a channel state between each transmit antenna and each receive antenna. Accordingly, a reference signal needs to be provided per transmit antenna, more specifically, per antenna port.

Reference signals can be classified into an uplink reference signal and a downlink reference signal. In LTE, the uplink reference signal includes:

i) a demodulation reference signal (DMRS) for channel estimation for coherent demodulation of information transmitted through a PUSCH and a PUCCH; and

ii) a sounding reference signal (SRS) used for an eNB to measure uplink channel quality at a frequency of a different network.

The downlink reference signal includes:

i) a cell-specific reference signal (CRS) shared by all UEs in a cell;

ii) a UE-specific reference signal for a specific UE only;

iii) a DMRS transmitted for coherent demodulation when a PDSCH is transmitted;

iv) a channel state information reference signal (CSI-RS) for delivering channel state information (CSI) when a downlink DMRS is transmitted;

v) a multimedia broadcast single frequency network (MBSFN) reference signal transmitted for coherent demodulation of a signal transmitted in MBSFN mode; and

vi) a positioning reference signal used to estimate geographic position information of a UE.

Reference signals can be classified into a reference signal for channel information acquisition and a reference signal for data demodulation. The former needs to be transmitted in a wide band as it is used for a UE to acquire channel information on downlink transmission and received by a UE even if the UE does not receive downlink data in a specific subframe. This reference signal is used even in a handover situation. The latter is transmitted along with a corresponding resource by an eNB when the eNB transmits a downlink signal and is used for a UE to demodulate data through channel measurement. This reference signal needs to be transmitted in a region in which data is transmitted.

Next-generation systems such as LTE-A consider configuration of inexpensive/low-specification UEs for data communication, such as metering, water level measurement, monitoring camera utilization and vending machine inventory reporting. In the case of such UEs, the quantity of transmitted data is small and uplink/downlink data transmission/reception are not frequently performed, and thus it is effective to reduce UE costs and decrease battery consumption on the basis of a low data transfer rate. Accordingly, a scheme in which the aforementioned UEs can use up to 6 RBs irrespective of system bandwidth is considered. However, such scheme may deteriorate performance. The aforementioned UEs may operate in poor radio environments (e.g. basements and warehouses). In this case, a method such as repetition can be used in order to increase UE coverage. When a coverage-improved UE attempts to increase a coverage level through repetition, the UE can reduce the number of repetitive transmissions through diversity gain by changing a band in which repetition is performed with time, thereby enhancing performance and battery life.

The present invention proposes a method of improving performance of long-term measurement such as RSRP (reference signal received power)/RSRQ (reference signal received quality) measurement of UEs which perform frequency hopping or frequency hopping and repetition.

RSRP

RSRP can be obtained by measuring a CRS of antenna port 0 in a long interval of approximately 200 ms. A UE can measure RSRP within a measurement bandwidth designated thereto in the operation band of the UE, irrespective of subband hopping or repetition.

To this end, an eNB can designate a measurement bandwidth of R RBs for the UE when the bandwidth that can be used by the UE is R RBs. Alternatively, the UE can assume the RSRP measurement bandwidth as R all the time irrespective of setting of the eNB.

A subband for measuring RSRP may be predefined (e.g. center 6 RBs) or determined by the eNB through RRC. There may be one or more subbands for RSRP measurement. In this case, the UE can measure RSRP when the subband corresponds to the operation subband thereof. The operation subband of the UE may be set as follows.
When the UE performs DRX (discontinuous reception), the operation subband may correspond to center 25 R RBs of the system bandwidth when the UE needs to receive a PSS/SSS (primary synchronization signal/secondary synchronization signal). When the UE need not receive the PSS/SSS, if the subband for RSRP measurement is set to a frequency other than the center R RBs, the operation subband may be the designated subband.
When the UE does not perform DRX (i.e. when the UE is active), the operation subband refers to a subband monitored by the UE. For example, if the UE receives a control channel in a set subband, the set subband is determined as the operation subband.
When the UE is RRC_IDLE, the operation subband refers to a subband monitored by the UE. If the UE monitors a PBCH in center 6 PRBs, center R RBs can correspond to the operation subband.

One or more subband sets for RSRP measurement may be defined. For example, center 6 RBs of the system bandwidth can be set to one subband set and the first and last subbands of the system bandwidth can be set to another subband set. The subband sets may be set through RRC and some or all subband sets may be predefined. In this case, one of the two subband sets may be signaled to the UE using DCI and the UE may perform measurement for the signaled subband set. Such measurement may be valid for a serving cell only. Furthermore, an aperiodic measurement trigger such as the aforementioned DCI may include the index of the corresponding subband set. In this case, reporting of corresponding aperiodic measurement refers to transmission of only a result of measurement performed in the signaled subband set.

When a measurement interval (≧one subframe) is set, the UE may measure RSRP by retuning to a subband for RSRP measurement at the interval. The eNB may set the duration, period and offset of the measurement interval for the UE through RRC. This can be applied only in case of RRC_CONNECTED, and setting of the duration, period and offset of the measurement interval can be applied according to PCell timing. The measurement interval may be identical to or different from a measurement gap set for the UE for inter-frequency measurement.

Such measurement gap can consider a case in which center 6 PRBs are set for monitoring. In this case, (intra-frequency) measurement for a neighboring cell can be considered. In other words, measurement with respect to the serving cell can be performed through the aforementioned method, and intra-frequency measurement with respect to a neighboring cell can be performed through the measurement gap. That is, it can be assumed that intra-frequency measurement of the UE with respect to the neighboring cell is performed in the same manner as inter-frequency measurement with respect to the neighboring cell, and requirements for intra-frequency neighboring cell measurement can be the same as requirements for intra-frequency measurement.

Even when the UE supports carrier aggregation, the measurement gap may be required for such measurement. In the case of Cat. 0 UEs or UEs which can monitor only a restricted bandwidth, it can be assumed that the measurement gap is needed without additional signaling. When the measurement gap is not set, a UE may not perform measurement. A UE which can perform measurement without the measurement cap can signal such capability through additional signaling.

Alternatively, the UE can retune to a subband for RSRP measurement to measure RSRP, as described above, by triggering a measurement interval through signaling such as an aperiodic measurement trigger. As a result, short-term RSRP can be obtained.

The above description assumes that the UE cannot measure RSRP on the basis of an RS monitored in subbands other than the subband designated by the eNB. However, since RSRP measurement is measurement of signal power in an RS, the UE may calculate RSRP by averaging signal power measured in the operation subband thereof irrespective of the position of the operation subband. In this case, additional signaling for RSRP may not be needed. The UE can perform measurement for the corresponding subband in an interval in which the UE can perform measurement.

RSRQ

RSRQ is represented by K*RSRP/RSSI (K being the number of RBs of a measurement bandwidth). Here, RSSI is total incoming power and refers to information similar to an SINR. Since it is desirable to measure the RSSI under the same conditions as RSRP measurement, the RSSI can be measured along with RSRP when the aforementioned method is used for RSRP measurement. When RSRP can be measured irrespective of subband, as described above, the above description can be applied to RSSI/RSRQ measurement. That is, the RSSI can be measured when the operation subband and the RSRP measurement subband overlap, or the RSSI can be measured by retuning to an RSRP measurement subband using a measurement interval. In addition, setting used for RSRP can be equally applied to RSSI/RSRQ measurement.

Alternatively, the RSSI may be measured through setting different from that for RSRP measurement. To this end, the aforementioned monitoring subband can be separately defined as an RSRP monitoring subband and an RSSI monitoring subband. In addition, the measurement interval can be separately defined as an RSRP measurement interval and an RS SI measurement interval. The monitoring subband and measurement interval may be used when RSRQ is calculated using an existing RSRP value to measure interference of a specific band in the case of RSSI. The measurement interval and measurement subband for the RSSI may be predefined independently of the measurement interval and measurement subband for RSRP and/or signaled to the UE by the eNB through RRC. Particularly, a subband for RSRQ measurement can be defined or selected as a subband in which SIB1 is transmitted. Alternatively, the RSSI may be assumed to be measured at the center of the system bandwidth all the time. For such measurement, it can be assumed that a measurement gap is needed for the serving cell. In other words, the RSSI is measured in the measurement gap and an RSRP measurement subframe may be varied according UE implementation.

RLM (Radio Link Monitoring)

RLM refers to measurement of performance of a hypothetical PDCCH based on a CRS. In-sync and out-of-sync can be determined according to Qin and Qout per block error rate (BLER). That is, the UE transmits out-of-sync through higher layer signaling when RLM<Qout and transmits in-sync through higher layer signaling when RLM<Qin. An RLM measurement scheme depends on UE implementation. In this case, Qin and Qout can be set and are defined as follows.

The threshold Qout is defined as the level at which the downlink radio link cannot be reliably received and shall correspond to 10% block error rate of a hypothetical PDCCH transmission taking into account the PCFICH errors with transmission parameters specified in Table below

TABLE 5

| Attribute | Value |
|---|---|
| DCI format | 1A |
| Number of control OFDM | 2; Bandwidth ≧10 MHz |
| symbols | 3; 3 MHz ≦ Bandwidth ≦ 10 MHz |
| | 4; Bandwidth = 1.4 MHz |
| Aggregation level (CCE) | 4; Bandwidth = 1.4 MHz |
| | 8; Bandwidth ≧3 MHz |
| Ratio of PDCCH RE energy | 4 dB; when single antenna port is used for |
| to average RS RE | cell-specific reference signal transmission |
| energy | by the PCell. |
| | 1 dB: when two or four antenna ports are |
| | used for cell-specific reference signal |
| | transmission by the PCell. |
| Ratio of PCFICH RE energy | 4 dB; when single antenna port is used for |
| to average RS RE | cell-specific reference signal transmission |
| energy | by the PCell. |
| | 1 dB: when two or four antenna ports are |
| | used for cell-specific reference signal |
| | transmission by the PCell. |

Note:
A hypothetical PCFICH transmission corresponding to the number of control symbols shall be assumed.

The threshold Qin is defined as the level at which the downlink radio link quality can be significantly more reliably received than at Qout and shall correspond to 2% block error rate of a hypothetical PDCCH transmission taking into account the PCFICH errors with transmission parameters specified in Table below.

TABLE 6

| Attribute | Value |
|---|---|
| DCI format | 1C |
| Number of control OFDM | 2; Bandwidth ≧10 MHz |
| symbols | 3; 3 MHz ≦ Bandwidth ≦ 10 MHz |
| | 4; Bandwidth = 1.4 MHz |
| Aggregation level (CCE) | 4 |
| Ratio of PDCCH RE energy | 0 dB; when single antenna port is used for |
| to average RS RE | cell-specific reference signal transmission |
| energy | by the PCell. |
| | −3 dB; when two or four antenna ports are |
| | used for cell-specific reference signal |
| | transmission by the PCell. |
| Ratio of PCFICH RE energy | 4 dB; when single antenna port is used for |
| to average RS RE | cell-specific reference signal transmission |
| energy | by the PCell. |
| | 1 dB: when two or four antenna ports are |
| | used for cell-specific reference signal |
| | transmission by the PCell. |

Note:
A hypothetical PCFICH transmission corresponding to the number of control symbols shall be assumed.

MTC UEs consider no transmission of the existing PDCCH. Accordingly, Qin and Qout as RLM performance may be defined on the basis of a BER of a PDSCH (or S-PDSCH on the assumption that a new PDSCH is defined as SIB) instead of BERs of the PDCCH and PCFICH on the assumption that control signals without the PDCCH are received. That is, the following format is possible.

The threshold Qout for MTC UEs is defined as the level at which the downlink radio link cannot be reliably received and shall correspond to 10% block error rate of hypothetical PDSCH transmission with transmission parameters specified in Table below.

TABLE 7

| Attribute | Value |
|---|---|
| Number of control OFDM | 2; Bandwidth ≧10 MHz |
| symbols | 3; 3 MHz ≦ Bandwidth ≦ 10 MHz |
| | 4; Bandwidth = 1.4 MHz |
| Ratio of PDSCH RE energy | 4 dB; when single antenna port is used for |
| to average RS RE energy | cell-specific reference signal transmission by |
| | the PCell. |
| | 1 dB: when two or four antenna ports are |
| | used for cell-specific reference signal |
| | transmission by the PCell. |
| PDSCH assumption | Center 6RBs transmission |
| | CQI: index 1 |
| | CRS based transmission |
| | no PMI, SFBC, rank 1 transmission: when |
| | two or more antenna ports are used for |
| | cell-specific reference signal transmission by |
| | the PCell. |

The threshold Qin for MTC UEs is defined as the level at which the downlink radio link quality can be significantly more reliably received than at Qout and shall correspond to 2% block error rate of hypothetical PDSCH transmission with transmission parameters specified in Table below.

TABLE 8

| Attribute | Value |
|---|---|
| Number of control OFDM | 2; Bandwidth ≧10 MHz |
| symbols | 3; 3 MHz ≦ Bandwidth ≦ 10 MHz |
| | 4; Bandwidth = 1.4 MHz |
| Ratio of PDSCH RE energy | 0 dB; when single antenna port is used for |
| to average RS RE energy | cell-specific reference signal transmission by |
| | the PCell. |
| | −3 dB; when two or four antenna ports are |
| | used for cell-specific reference signal |
| | transmission by the PCell. |
| PDSCH assumption | Center 6RBs transmission |
| | CQI: index 1 |
| | CRS based transmission |
| | no PMI, SFBC, rank 1 transmission: when |
| | two or more antenna ports are used for cell- |
| | specific reference signal transmission by the |
| | PCell. |

The UE may use only a narrower subband of R RBs (e.g. 6 RBs) instead of the existing system bandwidth. Accordingly, RLM needs to be performed based on the result measured in the corresponding R RBs and Qin and Qout need to be tested only in the corresponding R RBs. A measurement subband for RLM may be a center subband or a subband in which SIB1 for an MTC UE is transmitted. The measurement subband may be measured in a measurement subband list for measuring RSRP and/or RSRQ or a separate measurement subband set for RLM may be defined through RRC. According to LTE TS 36.213, RLM may be measured with the following frequency.

In non-DRX mode operation, the physical layer in the UE shall every radio frame assess the radio link quality, evaluated over the previous time period defined in TS 36.331, against thresholds (Qout and Qin) defined by relevant tests in TS36.331.

In DRX mode operation, the physical layer in the UE shall at least once every DRX period assess the radio link quality, evaluated over the previous time period defined in TS36.331, against thresholds (Qout and Qin) defined by relevant tests in TS36.331.

In a non-DRX mode, at least one RLM is performed per radio frame at an interval of SIB1. That is, at least one RLM can be performed at the interval of SIB1.

When RLM is set to be measured in a subband in which SIB1 is transmitted, the UE may not always perform RLM measurement since the UE does not receive SIB1 all the time. Considering this case, RLM may be assumed to be measured in the operation subband or to be measured when the same subband as the subband in which SIB1 is transmitted is monitored. For example, if paging and SIB1 are transmitted in the same subband, RLM can be performed once within a paging occasion interval. If CSS monitoring is performed in the same subband as the subband in which SIB1 is transmitted, CSS monitoring may be set to be measured once within a monitoring interval.

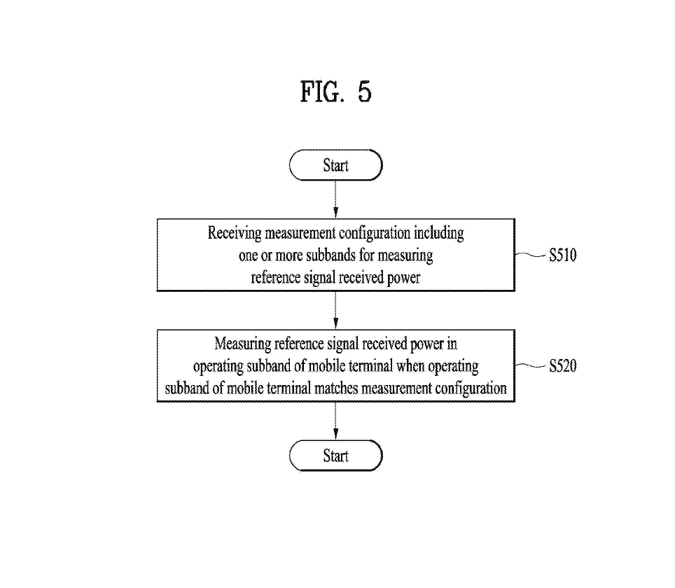

FIG. 5 illustrates an operation according to an embodiment of the present invention.

FIG. 5 illustrates a method of reporting a channel state in a wireless communication system. The UE can operate while retuning to a plurality of narrow bands. The UE may receive measurement setting including information about one or more subbands for receive power measurement from a specific cell (S510). The UE may measure receive power in the operation subband thereof when the operation subband corresponds to the measurement setting (S520).

The measurement setting may include control information indicating one of a plurality of subband sets configured for the UE.

In addition, the measurement setting may include information on a measurement interval for receive power measurement, and the measurement interval information may include the duration, period or offset of the interval for receive power measurement. Furthermore, the measurement interval may be the same as a measurement gap for inter-frequency measurement, which is set for the UE.

The UE may perform receive power measurement with respect to a neighboring cell in the measurement interval information corresponding to the measurement gap.

The operation subband may include a specific number of resource blocks (RBs) corresponding to the center of the system bandwidth when the UE needs to receive a PSS/SSS in the DRX (discontinuous reception) mode. When the UE is not in the DRX mode, the operation subband may include a subband monitored by the UE. When the UE is in an RRC_IDLE state, the operation subband may include a subband monitored by the UE.

While embodiments of the present invention have been described with reference to FIG. 5, the embodiments with respect to FIG. 5 may alternatively or additionally include at least part of the aforementioned embodiments.

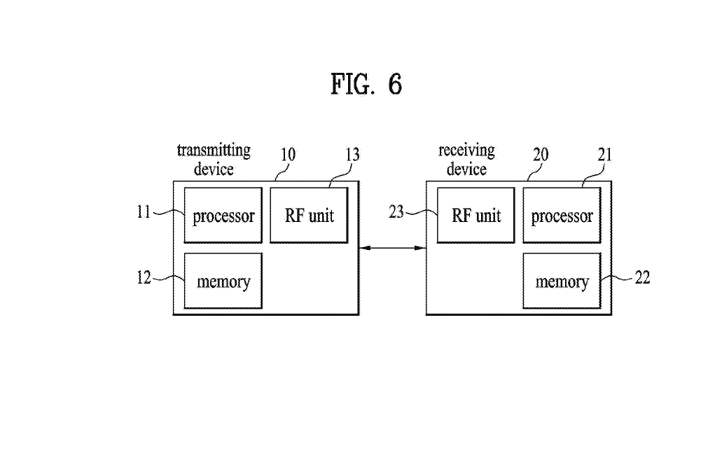

FIG. 6 is a block diagram of a transmitting device 10 and a receiving device 20 configured to implement exemplary embodiments of the present invention. Referring to FIG. 6, the transmitting device 10 and the receiving device 20 respectively include radio frequency (RF) units 13 and 23 for transmitting and receiving radio signals carrying information, data, signals, and/or messages, memories 12 and 22 for storing information related to communication in a wireless communication system, and processors 11 and 21 connected operationally to the RF units 13 and 23 and the memories 12 and 22 and configured to control the memories 12 and 22 and/or the RF units 13 and 23 so as to perform at least one of the above-described embodiments of the present invention.

The memories 12 and 22 may store programs for processing and control of the processors 11 and 21 and may temporarily storing input/output information. The memories 12 and 22 may be used as buffers. The processors 11 and 21 control the overall operation of various modules in the transmitting device 10 or the receiving device 20. The processors 11 and 21 may perform various control functions to implement the present invention. The processors 11 and 21 may be controllers, microcontrollers, microprocessors, or microcomputers. The processors 11 and 21 may be implemented by hardware, firmware, software, or a combination thereof. In a hardware configuration, Application Specific Integrated Circuits (ASICs), Digital Signal Processors (DSPs), Digital Signal Processing Devices (DSPDs), Programmable Logic Devices (PLDs), or Field Programmable Gate Arrays (FPGAs) may be included in the processors 11 and 21. If the present invention is implemented using firmware or software, firmware or software may be configured to include modules, procedures, functions, etc. performing the functions or operations of the present invention. Firmware or software configured to perform the present invention may be included in the processors 11 and 21 or stored in the memories 12 and 22 so as to be driven by the processors 11 and 21.

The processor 11 of the transmitting device 10 is scheduled from the processor 11 or a scheduler connected to the processor 11 and codes and modulates signals and/or data to be transmitted to the outside. The coded and modulated signals and/or data are transmitted to the RF unit 13. For example, the processor 11 converts a data stream to be transmitted into K layers through demultiplexing, channel coding, scrambling and modulation. The coded data stream is also referred to as a codeword and is equivalent to a transport block which is a data block provided by a MAC layer. One transport block (TB) is coded into one codeword and each codeword is transmitted to the receiving device in the form of one or more layers. For frequency up-conversion, the RF unit 13 may include an oscillator. The RF unit 13 may include Nt (where Nt is a positive integer) transmit antennas.

A signal processing process of the receiving device 20 is the reverse of the signal processing process of the transmitting device 10. Under the control of the processor 21, the RF unit 23 of the receiving device 10 receives RF signals transmitted by the transmitting device 10. The RF unit 23 may include Nr receive antennas and frequency down-converts each signal received through receive antennas into a baseband signal. The RF unit 23 may include an oscillator for frequency down-conversion. The processor 21 decodes and demodulates the radio signals received through the receive antennas and restores data that the transmitting device 10 wishes to transmit.

The RF units 13 and 23 include one or more antennas. An antenna performs a function of transmitting signals processed by the RF units 13 and 23 to the exterior or receiving radio signals from the exterior to transfer the radio signals to the RF units 13 and 23. The antenna may also be called an antenna port. Each antenna may correspond to one physical antenna or may be configured by a combination of more than one physical antenna element. A signal transmitted through each antenna cannot be decomposed by the receiving device 20. A reference signal (RS) transmitted through an antenna defines the corresponding antenna viewed from the receiving device 20 and enables the receiving device 20 to perform channel estimation for the antenna, irrespective of whether a channel is a single RF channel from one physical antenna or a composite channel from a plurality of physical antenna elements including the antenna. That is, an antenna is defined such that a channel transmitting a symbol on the antenna may be derived from the channel transmitting another symbol on the same antenna. An RF unit supporting a MIMO function of transmitting and receiving data using a plurality of antennas may be connected to two or more antennas.

The transmitting device and/or the receiving device may be configured as a combination of one or more embodiments of the present invention.

The embodiments of the present application has been illustrated based on a wireless communication system, specifically 3GPP LTE (-A), however, the embodiments of the present application can be applied to any wireless communication system in which interferences exist.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of measuring and reporting radio resources by a mobile terminal operating while retuning to a plurality of subbands in a wireless communication system, comprising:
receiving measurement configuration including one or more subbands for measuring a reference signal received power from a specific cell; and
measuring a reference signal received power in an operating subband of the mobile terminal when the operating subband of the mobile terminal matches the measurement configuration.

2. The method according to claim 1, wherein the measurement configuration is received through control information indicating one of a plurality of subband sets configured for the mobile terminal.

3. The method according to claim 1, wherein the measurement configuration includes information about a measurement time duration for measuring the reference signal received power,
wherein the information about the measurement time duration includes duration, period or offset of the measurement time duration for measuring the reference signal receive power.

4. The method according to claim 3, wherein the measurement time duration corresponds to a measurement gap for inter-frequency measurement, configured for the mobile terminal.

5. The method according to claim 4, further comprising measuring a reference signal received power for a neighboring cell in the measurement time duration corresponding to the measurement gap.

6. The method according to claim 1, wherein the operating subband includes a specific number of resource blocks (RBs) in the center of a system bandwidth when the mobile terminal needs to receive a PSS/SSS (primary synchronization signal/secondary synchronization signal) in a discontinuous reception (DRX) mode.

7. The method according to claim 1, wherein the operating subband includes a subband monitored by the mobile terminal when the UE is not in the DRX mode.

8. The method according to claim 1, wherein the operating subband includes a subband monitored by the UE when the UE is in an RRC_IDLE state.

9. A mobile terminal configured to measure and report radio resources in a wireless communication system and to operate while retuning to a plurality of subbands, comprising:
a radio frequency (RF) unit; and
a processor configured to control the RF unit,
wherein the processor is configured to receive measurement configuration including one or more subbands for measuring a reference signal received power from a specific cell and to measure a reference signal received power in an operating subband of the mobile terminal when the operating subband of the mobile terminal corresponds to the measurement configuration.

10. The mobile terminal according to claim 9, wherein the measurement configuration is received through control information indicating one of a plurality of subband sets configured for the mobile terminal.

11. The mobile terminal according to claim 9, wherein the measurement configuration includes information about a measurement time duration for measuring the reference signal received power,
wherein the information about the measurement time duration includes duration, period or offset of the measurement time duration for measuring the reference signal received power.

12. The mobile terminal according to claim 11, wherein the measurement time duration corresponds to a measurement gap for inter-frequency measurement, configured for the mobile terminal.

13. The mobile terminal according to claim 12, wherein the processor is configured to measure a reference signal received power for a neighboring cell in the measurement time duration corresponding to the measurement gap.

14. The mobile terminal according to claim 9, wherein the operating subband includes a specific number of resource blocks (RBs) in the center of a system bandwidth when the mobile terminal needs to receive a PSS/SSS (primary synchronization signal/secondary synchronization signal) in a discontinuous reception (DRX) mode.

15. The mobile terminal according to claim 9, wherein the operating subband includes a subband monitored by the mobile terminal when the mobile terminal is not in the DRX mode.

16. The mobile terminal according to claim 9, wherein the operating subband includes a subband monitored by the mobile terminal when the mobile terminal is in an RRC_IDLE state.
